(19) United States
(12) Patent Application Publication
(10) Pub. No.: US 2006/0248785 A1
(43) Pub. Date: Nov. 9, 2006

(54) Nit stripping device

(76) Inventor: Amy Shelton, Knoxville, TN (US)

Correspondence Address: PITTS AND BRITTIAN P C, P O BOX 51295, KNOXVILLE, TN, 37950-1295, US

(21) Appl. No.: 11/121,623

(22) Filed: May 4, 2005

(51) Int. Cl. A01M 3/00

(52) U.S. Cl. 43/134; 43/132.1

(57) ABSTRACT

A nit picking device and method for mechanically stripping nits, eggs, and lice from human hair. The device includes a pair of cooperating tongs each of which is elongated and joined at one end to the juxtaposed end portion of the cooperating tong. The opposite ends of the tong serve to carry an abrasive pad capable of stripping nits from nit laden human hair shafts. As the pads with human hair gripped there between are moved along the length of the hair, the nits are removed from the shafts and in one embodiment capture at least in part in the pads carried by tongs. In another embodiment, the tongs themselves are provided with an abrasive surface suitable for stripping nits as the tongs grip the hair and are moved along the length thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a method and device for removing nits, eggs and lice from human hair and more specifically concerns a method and device which serves to mechanically strip nits from human hair as abrasive pads or other suitable material are moved along the length of the nit-laden shafts gripped therebetween.

2. Description of the Related Art

Mechanical devices suitable for extracting nits from human hair have hereto before been known. Known devices generally include a comb having one or more rows of teeth that are selectively spaced to aid in combing head lice, nits, and eggs from human hair. Certain devices such as U.S. Pat. No. 6,098,633, include a plurality of teeth rows spaced such that the first row performs a course combing for head lice, nits and eggs and a second row of teeth performs a more fine filtering of head lice, nits and eggs. U.S. Pat. No. 6,086,682 discloses a combing device which is combined with a vacuum cleaner such that nits, eggs, and head lice removed by the closely-spaced comb teeth can be drawn into a vacuum cleaner hose and deposited at a remote location. Other known devices include teeth which maybe mechanically adjusted such that the comb can be used for different textures of hair and to aid in cleaning.

Other known devices are shown in the following patents: U.S. Pat. Nos. D274,658, D275,804, D289,567, D307,192, D365,662, 1,950,667, 2,477,245, 4,819,670, 4,936,259, 5,636,646, 6,006,758, 6,158,443, 6,524,604, 6,541,455, and 6,565,665.

### BRIEF SUMMARY OF THE INVENTION

The present invention provides a device and method for removing nits, eggs, and lice from human hair. In the preferred embodiment of the invention, a pair of cooperating tongs carry suitable abrasive pads or suitable sheets of abrasive material. Human hair shafts laden with nits, eggs, or lice are gripped between the pads and as the pads are moved in this gripping relationship along the length of the hair, the nits, eggs, and lice are mechanically stripped. In a preferred embodiment, the tongs are pivotably connected at one end by a suitable spring mechanism which biases the tongs and the pads carried thereby to an open position ready to receive infested hair shafts for gripping and stripping.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates use of the device and method in stripping nits, lice, and eggs from hair shafts of a child.

FIG. 2A discloses a perspective view of a nit picking device having scouring pads carried by a pair of cooperating tongs pivotably connected at one end.

FIG. 2B discloses the tongs of FIG. 2A with the pads, also shown, removed for purposes of illustration.

FIG. 3A discloses a side elevation view of the device and tongs shown in FIGS. 2A and 2B.

FIG. 3B discloses an alternate embodiment of the device including a pair of tongs having pads which are of a lesser thickness and which accordingly require less spacing at the connected and pivoting end portions of the tongs.

FIG. 3C discloses a nit picking device constructed within accordance of various features of the present invention having a thin layer of abrasive cloth or other suitable scouring material mounted at the stripping ends of the tongs.

FIG. 3D shows an alternate embodiment of a nit picking device with the connected ends of the tongs being integrally formed.

FIG. 3E show the stripping ends of the tongs configured in a serrated design to aid the mechanical gripping and stripping of the nits, eggs, and lice from the infested hair.

FIGS. 4A-G disclose various embodiments of the pivotably connected ends of the tong certain of which incorporate springs and other mechanical arrangements for biasing the tongs to an open position and for spacing the tongs by the desired and preselected distances to aid a more complete mechanical engagement along the gripping ends of the tongs.

### DETAILED DESCRIPTION OF THE INVENTION

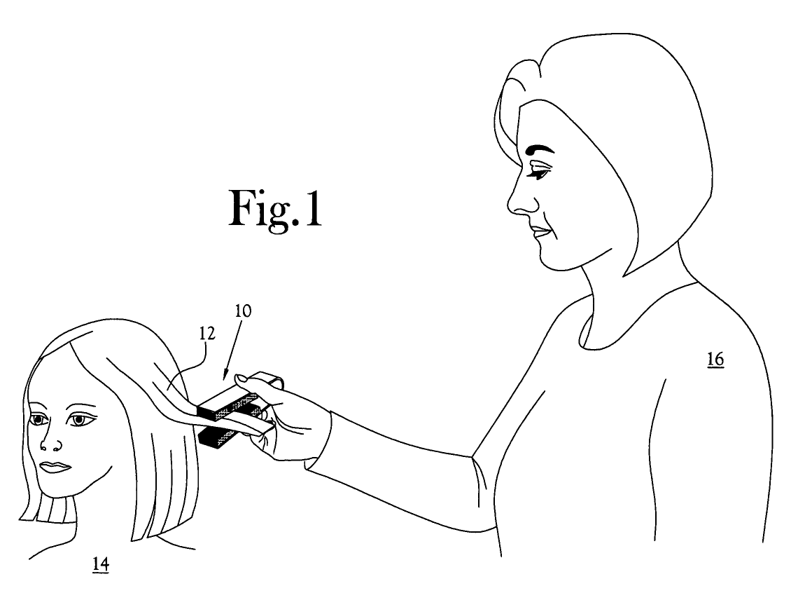

A nit stripping device incorporating various features of the present invention is illustrated generally at 10 in FIG. 1. This nit stripping device is designed to grip nit laden hair shafts 12 such as shown on the child 14. As the operator 16 grips the infested hair shafts 12 with the device and moves it along the length of the hair, as by pulling, nits, eggs, and lice are stripped therefrom.

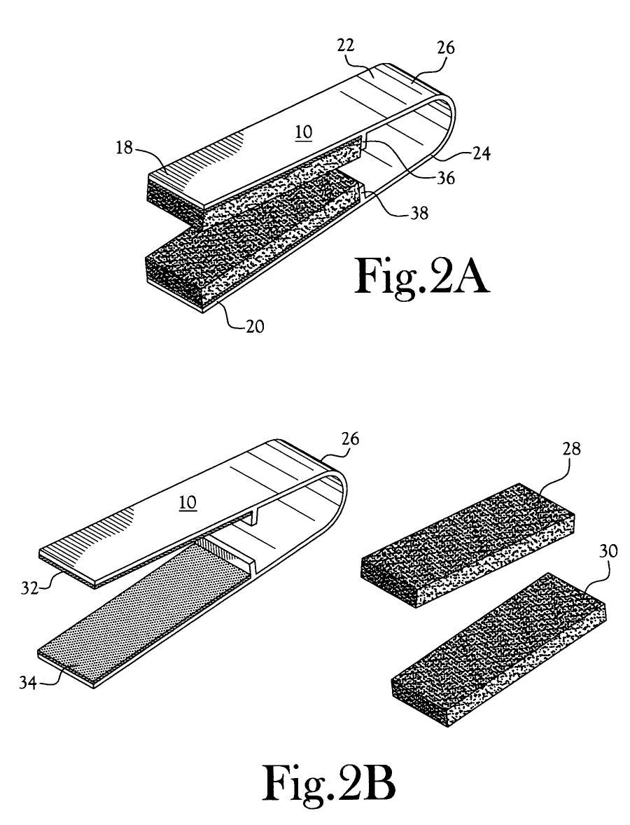

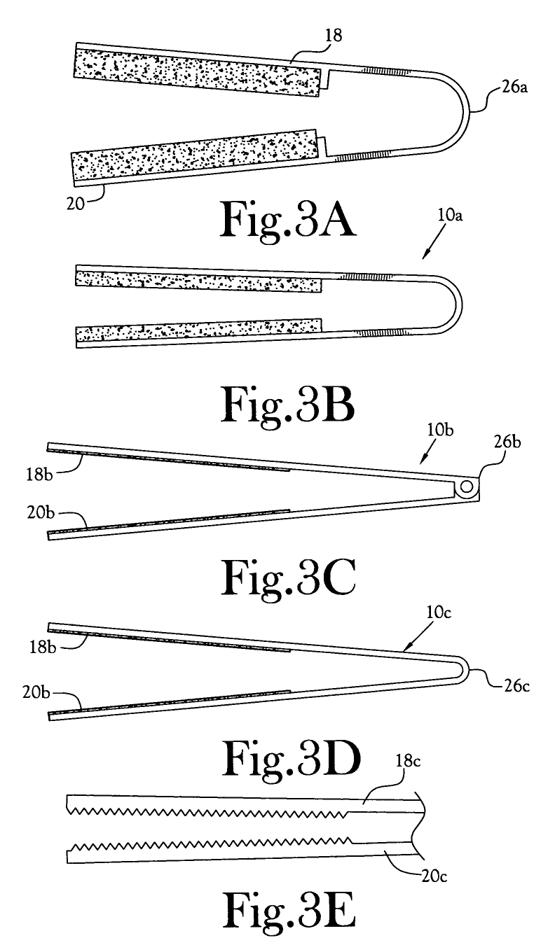

To this end, the device 10 includes a pair of tongs 18, 20 as shown in FIGS. 2A, 2B, and 3A. These tongs 18, 20 are pivotably connected at their end portions 22, 24 respectively. In this connection, it is noted that the tongs 18, 20 are fabricated from a pliable material which in the embodiment shown in FIGS. 2A, 2B, and 3A form a elongated bent portion of plastic, aluminum or the like, such that the joined ends of 22, 24 are connected by the integrally formed arcuate section 26 shown in FIGS. 2A, 2B, and 3A.

Pads 28, 30 are mounted on the gripping ends of the tongs 18, 20, respectively, opposite the pivotably connected ends 22, 24 as shown in FIGS. 2A and 2B. These pads 28, 30 are preferably releasably mounted on the ends of the tongs by suitable Velcro strips such as strips 32, 34 shown in FIG. 2B. These strips are secured to cooperating Velcro members carried on the juxtaposed and operatively mounted pads. It is also noted in FIGS. 2A, 2B, and 3A, that suitable stops 36, 38 serve to assist in the placement of the pads 28, 30, respectively, in a proper alignment with each other. In the embodiment shown in FIG. 3B, the device 10a illustrates an alternate embodiment which is provided with tongs which do not include the stops shown in FIGS. 2A, 2B, and 3A. It will also be noted that the pads used in connection with the device 10a in FIG. 3B is of a lesser thickness than the pads shown in connection with the device illustrated in FIGS. 2A, 2B, and 3A.

FIG. 3C discloses a nit stripping device 10b having an abrasive cloth or other thin layer of material mounted on the gripping end portions of the tongs. This thin layer material serves to mechanically grip the nit laden hair and strip the nits, eggs, and lice therefrom. The pads 18, 20 shown in FIGS. 2A, 2B, and 3A serve to capture the stripped nits, eggs, and lice within the pads themselves and to this end are fabricated from an abrasive and porous material. These pads can be discarded after use. However, the thin layers of the materials 18b, 20b will allow the nits, eggs, and lice to fall to the floor as they are not particularly designed to capture the infestations therein. It will also be noted that the device 10b shown in FIG. 3C is provided with a pivotal connection 26b that mechanically joins the juxtaposed and pivotably connected ends of the tongs. It will also be noted that this connection 26b provides less spacing between the tongs than is shown in connection with FIGS. 2A, 2B, and 3A, since the effective thickness of the pads or abrasive sheet or material such as sand paper mounted at the cooperating gripping ends of the tongs is of a lesser dimension than shown in connection with FIGS. 2A, 2B, and 3A. Other suitable scouring devices of synthetic and natural material can be used as the pads as can sandpaper of coarse to fine abrasion.

FIG. 3D shows a nit stripping device 10c having thin pads or abrasive material 18b, 20b mounted on the gripping and stripping ends of the tongs. This embodiment of the device includes a connection 26c which joins the pivotably connected ends of the tongs. The mechanical connection 26c provides lesser spacing between the tongs than that shown in connection with FIGS. 2A, 2B, and 3A to aid mechanical connection and gripping and stripping of the hair between the pads.

FIG. 3E shows an alternate embodiment of the gripping ends of the tongs. More specifically, the gripping end 18c and the gripping end 20c of the tongs are provided with cooperating serrations which mesh when closed to aid in the mechanical gripping and stripping of nits, eggs, and lice as the engaged tongs are drawn along the length of the human hair.

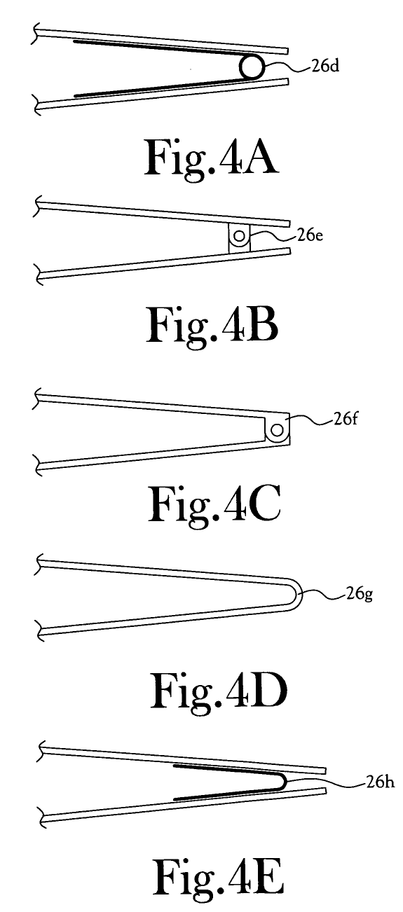

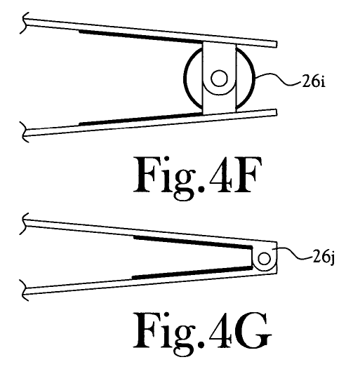

FIG. 4a-4g discloses alternate embodiments of connections for joining the pivotably connected ends of the tongs. Moreover, it would be seen that these mechanical connections serve to space the tongs by a desired distance such that as the tongs are pivoted the pads carried at their opposite gripping ends will form a cooperating gripping surfaces to grip the nit laden hair therebetween. Specifically, the embodiment shown in FIG. 4A shows a compression spring 26d connecting the pivotably connected ends of the tongs for biasing the tongs to an open position such that upon application of gripping forces to the tongs the pads are forced against each other for gripping nit laden hair therebetween.

FIG. 4B discloses a mechanical connection 26e which in the illustrated embodiment is not spring biased. Thus, a user would need to mechanically open and close these tongs for receiving and gripping the hair respectively.

An alternate embodiment of a mechanical connection is shown 26f in FIGS. 4C and 26g in FIG. 4D. Yet another mechanical connection is shown 26h in FIG. 4E. The embodiment shown in 26h is mechanically similar to the embodiment shown in FIG. 4D 26g and FIG. 3D 26c except that it is not integrally connected with the tongs as is the connection in FIG. 4D.

The embodiment shown in FIG. 4F combines the mechanical connection 26e shown in FIG. 4B and a spring of a type shown 26d in FIG. 4A such that the tongs are biased toward an open position. Similarly, the mechanical connection shown in FIG. 4G 26j combines the mechanical connections of 26f, 26h such that the tongs are biased toward an open position.

In operation, a method is provided for removing nits, eggs, and lice from human hair by first placing nit laden hair shafts between opposed pads of an abrasive material. Pressure is applied to the pad such that the shafts are gripped there between. Preferably the pads are mounted on suitable tongs such that this pressure is applied to the tongs, and this pressure is transmitted into the pads for gripping the hair. The nits, eggs, and lice are mechanically stripped from the hair shafts by moving the opposed pads along the length of the hair gripped there between.

From the foregoing detailed description, it will be recognized by those skilled in the art that an improved device and method has been provided for removing as by stripping nits, eggs, and lice from infested human hair shafts. In one embodiment the nit stripping device is provided with suitable abrasive pads that serve to capture the dislodged infestations therein. In another embodiment, the pads are of a thinner design and capable of stripping but not capturing the nits, eggs, and lice. In yet another embodiment, the tongs of the nit picking device itself are designed to mechanically mesh and cooperate for stripping the infestations from the hair shafts.

While the present invention has been illustrated by description of several embodiments and the illustrative embodiments have been described in considerable detail, it is not the intent of the applicant to restrict or in any way limit the scope of the appended claims to such detail. Additional advantages and modifications may readily appear to those skilled in the art. The invention in its broader aspects is therefore not limited to the specific details, representative apparatus and methods, illustrative examples shown and described. Accordingly, departures may be made from such details without departing from the spirit of scope of the applicant's general inventive concept.

1. A nit stripping device for mechanically extracting nits, eggs, and lice from human hair comprising:
a pair of cooperating tongs each of said tongs being elongated and having a first end juxtaposed to and joined with a first end of the cooperating tong;
each of said tongs including an opposite gripping end section such that said tongs are free to move toward and away from each other and including opposed inner surfaces;
pads carried by the opposed section of the opposite ends for mechanically gripping strands of human hair between said pads and whereby said nits, eggs, and lice are mechanically stripped from hair shafts as said pads are held against said hair shafts by said tongs and slid along the nit laden hair shafts.

2. The device of claim 1 wherein said pads are releasably mounted on said tongs and can be removed for cleaning or replacement.

3. The device of claim 1 wherein said pads serve to trap said nits therein and can be discarded after use thereby disposing of the nits, eggs, and lice trapped by said pads.

4. The device of claim 1 wherein each of said pads comprise a thin abrasive sheet which grip the hair shafts there between for stripping nits thereupon.

5. The device of claim 4 wherein said pads are made from sand paper.

6. The device of claim 4 wherein said pads are made from a scouring material.

7. The device of claim 1 wherein said first ends of said tongs are joined with a spring which biases the tongs to an open position.

8. A method for removing nits, eggs, and lice from human hair comprising the steps of:
placing nit-laden hair shafts between opposed pads of abrasive material;
applying pressure to the pads such that the shafts are gripped thereby between; and
mechanically stripping the nits from the hair shafts by moving the opposed pads gripping the hair along the length thereof.

9. The method for removing nits, eggs and lice from human hair of claim 8 including the step of mounting each of said pads on a respective tong and applying forces to said tongs such that said pads were moved towards each other with gripping said nit-laden hair shafts there between.
